(19) United States
(12) Patent Application Publication
(10) Pub. No.: US 2025/0128166 A1
(43) Pub. Date: Apr. 24, 2025

(54) GAMING SYSTEM AND METHOD

(71) Applicant: Sony Interactive Entertainment Inc., Tokyo (JP)

(72) Inventors: Jun Murakawa, London (GB); Alan Murphy, London (GB); Guy Moss, London (GB); Lewis Thresh, London (GB)

(73) Assignee: Sony Interactive Entertainment Inc., Tokyo (JP)

(21) Appl. No.: 18/908,908

(22) Filed: Oct. 8, 2024

(30) Foreign Application Priority Data
Oct. 19, 2023 (GB) 2316010.4

(51) Int. Cl. A63F 13/63; A63F 13/355; A63F 13/44; A63F 13/67; A63F 13/79

(52) U.S. Cl. CPC A63F 13/63; A63F 13/355; A63F 13/44; A63F 13/67; A63F 13/79; A63F 2300/538

(57) ABSTRACT

A gaming system, comprising: generating circuitry configured to generate, for a current gaming session, a virtual environment comprising a plurality of portions, wherein the generating circuitry is configured to instantiate a subset of a total number of elements of a first video game within a first portion of the virtual environment; receiving circuitry configured to receive, from a user input device, input signals indicating a user's level of engagement during the user's interaction with the first portion; and determining circuitry comprising a determining model trained to determine a second video game based on the first portion and the received input signals; wherein the generating circuitry is configured to instantiate a subset of a total number of elements of the second video game within a second portion of the virtual environment.

### FIELD OF INVENTION

The present invention relates to a gaming system and method.

### BACKGROUND

In order to reach a wider audience, some video game developers may wish to release a demonstration version (demo) of a video game prior to/alongside a full release of the video game, the demo typically consisting of a part of the video game (one or more levels thereof, for example). The demo thus enables users to play this part of the video game, and thereby determine whether or not they would enjoy playing the full release video game.

Video game demos have been released as bonus disks comprised within video game magazines, or more recently as downloads from a gaming network. In the former case, issues relating to the transport of physical media for temporary purposes arise, such as logistical challenges, inability to deliver updates, and the potential for unnecessary electronic waste (also known as e-waste), particularly if the user then goes on to purchase a copy of the full game. In the latter case, game files comprising the video game environment are typically transferred from a server to the user's computer/games console. Given that video games nowadays strive to provide a rich immersive experience to users, the virtual environments thereof are typically large in terms of file size. This typically means that transferring such game files take a long time. The present invention seeks to alleviate or mitigate this issue.

### SUMMARY OF THE INVENTION

In a first aspect, a gaming system is provided in claim 1.

In another aspect, a gaming method is provided in claim 12.

Further respective aspects and features of the invention are defined in the appended claims.

### BRIEF DESCRIPTION OF THE DRAWING

Embodiments of the present invention will now be described by way of example with reference to the accompanying drawings, in which:

FIG. 1 schematically illustrates a network environment in which embodiments of the present description may operate;

FIG. 2 schematically illustrates an entertainment system operable as a client device;

FIG. 3 schematically illustrates an entertainment system operable as a server;

FIG. 4 schematically illustrates a gaming system in accordance with embodiments of the present description; and

FIG. 5 schematically illustrates a gaming method in accordance with embodiments of the present description.

### DESCRIPTION OF THE EMBODIMENTS

A gaming system and method are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

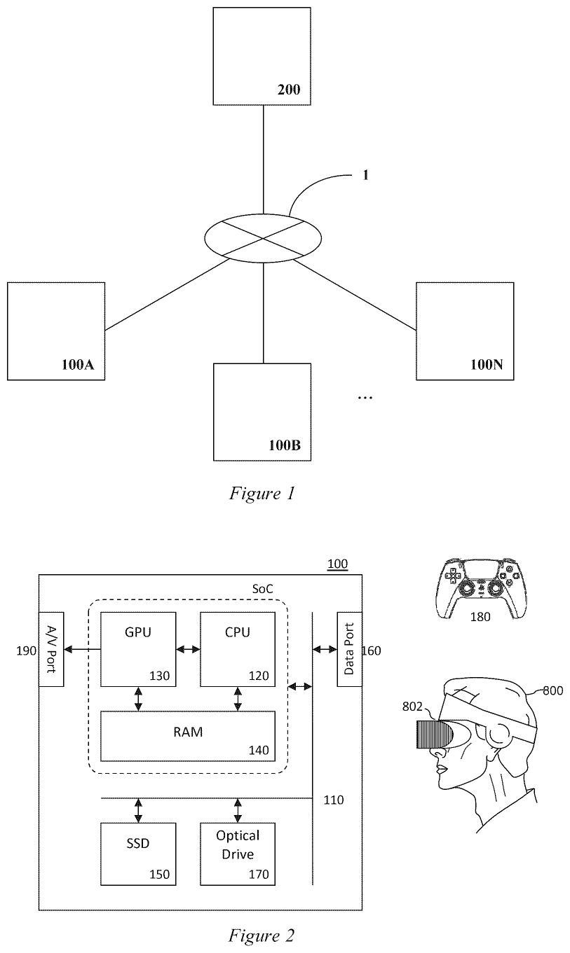

Referring to FIG. 1, an example of an entertainment system 100 is a computer or console.

The entertainment system 10 comprises a central processor or CPU 120. The entertainment system also comprises a graphical processing unit or GPU 130, and RAM 140. Two or more of the CPU, GPU, and RAM may be integrated as a system on a chip (SoC).

Further storage may be provided by a disk 150, either as an external or internal hard drive, or as an external solid state drive, or an internal solid state drive.

The entertainment device may transmit or receive data via one or more data ports 160, such as a USB port, Ethernet® port, Wi-Fi® port, Bluetooth® port or similar, as appropriate. It may also optionally receive data via an optical drive 170.

Audio/visual outputs from the entertainment device are typically provided through one or more A/V ports 90 or one or more of the data ports 160.

Where components are not integrated, they may be connected as appropriate either by a dedicated data link or via a bus 110.

An example of a device for displaying images output by the entertainment system is a head mounted display ‘HMD’ 802, worn by a user 800.

Interaction with the system is typically provided using one or more handheld controllers 180.

Examples of servers 200 include data centres, computers, laptops and entertainment systems.

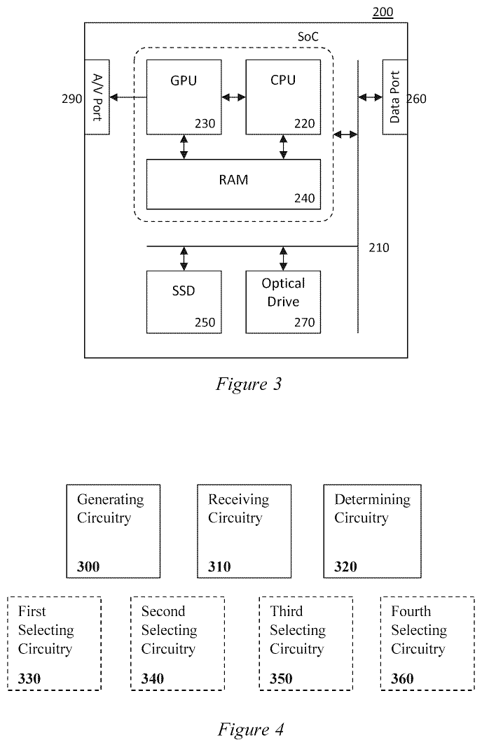

FIG. 3 depicts an entertainment system operable as server 200. As will be appreciated by persons skilled in the art, the parts of the entertainment system are similar to that of FIG. 2, albeit that the reference numerals have been changed.

As mentioned previously, current methods of releasing video game demos have various issues such as the potential generation of e-waste due to the disposal of bonus disks, and large bandwidth requirements and long periods of time associated with downloading large game files over a network.

Such issues may be alleviated or mitigated by implementing means to generate a virtual environment comprising a plurality of portions, where a first portion may be filled with elements of a first video game (characters, objects, scenery, music, sound effects, and the like). Such means would determine the user's video game preferences based on their reactions to/interactions with the first portion, and consequently determine a second video game whose elements should fill a second portion. Optionally, such means may repeat this process as often as necessary to determine yet further video games whose elements may be interacted with by the user within yet other portions of the virtual environment.

In this way, the user may successively play multiple video game demos that have been generated on-the-fly, which would eliminate the need for a disk such as a magazine bonus disk. Moreover, where generation of the virtual environment is carried out by server 200, and rendered image and/or audio data is streamed to client device(s) 100, then the need for downloading large game files may be eliminated.

Alternatively, where virtual environment generation is carried out by client device(s) 100, then the amount of data to be downloaded onto client device(s) 100 may be reduced; rather than downloading virtual environments corresponding to each of the video games, certain parts thereof (such as characters, objects, in-game music, and the like) may instead be downloaded for use in the generated virtual environment.

In either case, by providing a single virtual environment and instantiating elements of video games within respective portions thereof reduces the amount of downtime or latency between completing/ending one video game experience and beginning another; rather than having terminate execution of a given demo and begin execution of another, the user may simply move to a different portion of the virtual environment or be given control of a different element (character, for example) located in the different portion. This also offers an advantage in the efficiency of the operation of the system; rather than loading an entirely new virtual environment for each game experience, a number of common elements or assets can be reused or maintained-thereby reducing the processing burden associated with each new experience.

### Gaming System

Accordingly, turning now to FIG. 4, in embodiments of the present description, a gaming system comprises: generating circuitry 300 configured to generate, for a current gaming session, a virtual environment comprising a plurality of portions, wherein generating circuitry 300 is configured to instantiate a subset of a total number of elements of a first video game within a first portion of the virtual environment; receiving circuitry 310 configured to receive, from a user input device, input signals indicating a user's level of engagement during the user's interaction with the first portion; and determining circuitry 320 comprising a determining model trained to determine a second video game based on the first portion and the received input signals; wherein generating circuitry 300 is configured to instantiate a subset of a total number of elements of the second video game within a second portion of the virtual environment.

As will be appreciated by persons skilled in the art, references to “determining model 320” may be taken to mean “determining circuitry 320 comprising a/the determining model”. As a non-limiting example of the gaming system in use, a user may wish to try out multiple video game demos in order to determine which full release video games they would enjoy playing. Accordingly, the user may turn on their client device 100 (games console, smartphone, laptop, or the like) in order to establish a current gaming session either locally on client device 100 or remotely by connecting to server 200 via network 1 (the Internet, LAN, WLAN, or the like).

Generating circuitry 300 may generate a virtual environment for the current gaming session. This virtual environment may comprise a plurality of portions. Each portion may be thought of as a part of the virtual environment within which elements of a respective one of a plurality of video games may be (eventually) instantiated. That is to say that the mapping/association of video games to portions (by way of instantiating the video games' elements into the portions) may be one-to-one or one-to-many, but not many-to-one. Thus, over the course of the current gaming session, the virtual environment may be gradually populated with elements of a plurality of video games, with each portion having instantiated therein elements of one of said video games.

Generating circuitry 300 (of client device 100 and/or server 200) may instantiate a subset of a first video game's elements into a first portion, and thereby provide the user with a demo of the first video game in an on-the-fly manner. The first video game and/or the specific elements thereof to be instantiated within the first portion may be selected randomly, by taking user preferences regarding entertainment media (music, films, TV series, and the like) into account, and/or by taking previous gaming sessions using embodiments of the present description into account, for example.

Once the first portion is populated (that is, has instantiated therein elements of the first video game), at least the first portion of the virtual environment may be rendered (and optionally streamed if rendered at server 200) for display to the user, and the user may interact with the first portion (by controlling one of the elements, for example).

In order to determine the user's level of engagement in the first video game, the input signals provided by the user to client device 100 during interaction with the first portion may be utilised. These input signals may comprise control signals (from a games controller, mouse and keyboard, or the like) for controlling one of the first video game's elements (a character from the first video game, for example) or for controlling the current gaming session (pausing the gaming session, skipping portions of the virtual environment), and/or may comprise signals received from gaze tracking systems (users typically look at objects they are interested in), microphones (increasingly loud voices, screams and shouts may indicate increasing levels of engagement), and/or biometric sensors (increasingly higher heart rates may indicate (increasing levels of engagement), for example.

More specifically, receiving circuitry 310 (of client device 100 and/or server 200) may receive these input signals, and determining model 320 (of client device 100 and/or server 200) may determine, based on the first portion and the received input signals, a second (subsequent) video game that the user is likely to prefer/be interested in. Determining model 320 may transmit information regarding this subsequent video game to generating circuitry 300, which may then instantiate a subset of elements thereof within a second portion of the virtual environment. Subsequently, at least the second portion may be rendered (and optionally streamed) for display to the user for interaction by the user. Thus, a second demo is provided to the user in an on-the-fly manner.

As a non-limiting example, generating circuitry 300 may populate the first portion with elements of a role-playing game (RPG). Receiving circuitry 310 may receive input signals provided by the user, and determining model 320 may determine that the user is not interested in this RPG by considering the rate at which input signals are being received (the lower the rate, the less likely the user is interested), the type of input signals received (if the inputs signal control the in-game character so as to avoid enemies rather than engage with them, then the user may be less likely to be interested), whether an input signal that terminates/skips the first portion is provided, the results of gaze tracking, audio data from a microphone, biometric data from sensors, and the like.

Determining model 320 may thus determine a second video game that does not resemble this RPG (a first person shooter (FPS) game, for example), and generating circuitry 300 may instantiate elements of the second video game into a second portion of the virtual environment.

Optionally, determining model 320 may similarly determine which elements of video games the user prefers/is interested in (potentially even regardless of the type/genre of video game). Using the above example, while determining model 320 determined that the user is not (that) interested in the RPG, it may also determine that the user likes the scenery objects of the RPG. For example, the input signals provided controlled the character to explore/wander around the first portion of the game, and gaze tracking results indicated that the user was looking at the tropical trees populating the first portion for a signification proportion of time spent within the first portion. Determining model 320 may use this information to determine that the FPS game should be one that comprises a tropical/jungle environment (an FPS game based on the Vietnam War, for example).

As will be appreciated by persons skilled in the art, a further (third) portion of the virtual environment may be populated with elements of a further (third) video game based on the determination as to whether the user was interested in the second portion and/or the determination with respect to the first portion. This process may continue on in a cyclical manner, with each successive portion being populated with elements of a respective video game that has been determined by determining circuitry 320 based on one or more previous portions of the virtual environment and the input signals received by receiving circuitry 310 during the user's interaction with the previous portion(s).

Thus, during the current gaming session, the user (in conjunction with a determining model) may find which games they would be interested in playing without having to use (and subsequently discard) bonus disks, and without having to download each video game's virtual environments from a server in full and in advance. This process is therefore made quicker and less wasteful relative to existing arrangements, as the amount of data required to be transmitted is significantly reduced through the selective obtaining of content for use in a common framework (that is, the respective portions of the virtual environment).

Moreover, this on-the-fly generation of demos may be beneficial in that a more unique demo experience is provided to users; different users may interact with different elements of the same video game. By considering the interests or preferences of different users, an experience can be tailored to them to increase engagement and reduce the amount of wasted data downloaded by a user (that is, data corresponding to content in which they have no interest).

### First Portion

In embodiments of the present description, generating circuitry 300 is configured to generate, for a current gaming session, a virtual environment comprising a plurality of portions, wherein generating circuitry 300 is configured to instantiate a subset of a total number of elements of a first video game within a first portion of the virtual environment. In embodiments of the present description, generating circuitry 300 may comprise one or more CPUs and/or GPUs in client device 100 (such as CPUs 120 and/or GPUs 130, for example) in the case of a locally established current gaming session, or one or more CPUs and/or GPUs in server 200 (such as CPUs 220 and/or GPUs 230, for example) in the case of a remotely established current gaming session.

Optionally, embodiments of the present description may comprise rendering circuitry configured to render (and optionally stream), for display to the user, at least the first portion. In embodiments of the present description, rendering circuitry may comprise one or more CPUs and/or GPUs in client device 100 (such as CPUs 120 and/or GPUs 130, for example) in the case of a locally established current gaming session, or one or more CPUs and/or GPUs in server 200 (such as CPUs 220 and/or GPUs 230, for example) in the case of a remotely established current gaming session.

As mentioned previously, each portion may be thought of as a part of the virtual environment within which elements of a respective one of a plurality of video games may be (eventually) instantiated. That is to say that the mapping/association of video games to portions (by way of instantiating the video games' elements into the portions) may be one-to-one or one-to-many, but not many-to-one.

The user may interact with a given portion by controlling a user-controllable element instantiated within that given portion (a controllable character, for example).

As will be appreciated by persons skilled in the art, moving between portions (and thus providing the user with a new/different video game to interact with) may be affected by disabling the user's control of a given user-controllable element within the given portion and enabling the user to control subsequent user-controllable element within a subsequent portion, for example. Alternatively, the move between portions may be effected by relocating a user-controllable element from the given portion to the subsequent portion. This move may be triggered by the user providing a skip signal for skipping the given portion, by a time spent within the given portion reaching a threshold interaction time, or by the user controlling their user-controllable element to move between portions.

A given portion of the virtual environment may be demarcated by one or more boundaries. The boundaries may prevent the user from accessing other portions of the virtual environment until they have sufficiently interacted with (or indicated that they wish to skip) the given portion. The boundaries in question may take on any form, such as walls in a building (the given portion may be a room in the building, for example), dry stone walls or rows of trees (the given portion may be a grassy field/farmland, for example), rows of buildings (the given portion may be a city plaza, for example), hills/mountains (the given portion may be a valley basin, for example), canals/rivers/lakes/seas (the given portions may be a small island, for example), invisible walls, and the like. Alternatively or in addition, elements of a given video game may be used to form the boundaries (vehicles, scenery objects, in-game characters, buildings, and the like).

Of course, in some cases the boundary may simply be indicated by a dashed line on the floor or a mesh wall or the like—in other words, the boundary may not be intended to be in keeping with the content that is displayed as may be the case in which particular elements (such as walls or rows of trees) are used to indicate the boundary.

The boundaries may have openings within them (doors, portals, gateways, windows, and the like) that permit a user-controllable element to move between portions, should the user wish to travel between portions (rather than provide a skip signal, for example).

Alternatively, the given portion may not be demarcated by boundaries that prevent the user from interacting with other portions. Rather, the given portion may be a predetermined area within the virtual environment within which elements of only one of a plurality of video games may be (eventually) instantiated. For example, the given portion may be a circular area within a part of the virtual environment, and generating circuitry 300 may be configured to instantiate elements of a given video game within that circular area. In this case, the user may be controlling a character within the circular area of the given portion, but may wish to interact with a different portion and so may control the character to leave the circular area without being prevented by a boundary/wall.

The size and/or shape of each portion may be made equal to every other portion. This may be beneficial in that generation of the virtual environment by generating circuitry 300 may be made more efficient; the virtual environment may be generated taking into account a predefined condition of equal portion sizes/shapes, and thus does not need to adjust portion size/shape on-the-fly (and thereby expend additional computational resources).

Alternatively, generating circuitry 300 may be configured to adjust the size and/or shape of a given portion in dependence upon the given video game whose elements are to be instantiated within the given portion; this may be based upon an identification of the title, genre, or one or more identified elements of the given video game, for instance. For example, if an open-world RPG is to have its elements instantiated within a given portion, then generating circuitry 300 may increase the size of the given portion in order to provide users with a greater sense of the open-world format of the RPG. As another example, generating circuitry 300 may adjust the size and/or shape of the given portion to accommodate the elements to be instantiated therein (making the portion large enough to accommodate a tank being driven by the user).

In any case, a first portion is populated with (has instantiated therein) elements of a first video game. More specifically, the number of elements instantiated within the first portion is less than (that is, a subset of) the total number of elements of the first video game. This is beneficial in that providing demos to users may be made more computationally efficient, as less elements of the video games are required to generate the demos. For example, rather than generating and rendering an entire video game level populated with all the elements of the video game that are associated with that level, a demo which still captures the essence or “feel” of the video game may be generated by using fewer elements, and thus using fewer computational resources. By reducing the computational expenditure, the rendering (and optional streaming of) image and/or audio data to client device 100 may be made more efficient, thus leading to smoother gameplay for the user (higher frame rates, less screen tearing, less input lag, and the like).

As mentioned previously, an element of a given video game may comprise one of: a virtual character (a user-controlled character, a friendly/enemy non-player character, or the like); a virtual object (a weapon, a vehicle, a building, a tree, an item of clothing, food, a portion, or the like); image data of one or more virtual characters and/or one or more virtual objects (rendered as a texture onto a virtual object such as wall, for example); a texture (a surface detail such as brickwork, wood grain, wallpaper, and the like, or patterns and/or colours, for example); a user interface, UI, element (a health bar, a stamina bar, a magic bar, an ammo counter, a speedometer, a countdown timer, or the like); an in-game sound effect (a gunshot, enemy grunt, footsteps, or the like); and at least a part of the given video game's soundtrack or musical score (incidental music, menu music, a character's leitmotif (or developments thereof), and the like).

By instantiating image data of virtual characters and/or objects, a more computationally efficient virtual environment generation may be achieved, as image data of a given virtual character/object is typically smaller in size (fewer bits, for example) than mesh/point cloud data of the virtual character/object with an associated texture, and the image data is typically overlaid as a texture rather than requiring more in-depth rendering processes such as physics modelling, shading, colouring and the like (as does the mesh/point cloud data).

In any case, it should be noted that the preceding examples are not exhaustive; persons skilled in the art will appreciate that video game elements other than those mentioned previously are considered within the scope of the present description.

As will be appreciated by persons skilled in the art, the first video game and/or elements thereof may be selected for the first portion using various different methods.

For example, a plurality of video games' elements may be stored alongside respective metadata within respective memory addresses of a memory of client device 100 and/or server 200 (such as a hard disk drive, SSD 150 or 250, or the like), the metadata of each element indicating the video game with which that element is associated.

Generating circuitry 300 may query/search the metadata for the video game title that is first alphabetically (the title begins with “A”, for example), and find all elements associated with the video game title. Generating circuitry 300 may thus select the first N sequential memory addresses that have stored therein elements of that video game. Thus, generating circuitry 300 may perform a sequential selection of video games and/or elements thereof.

Alternatively or in addition, embodiments of the present description may comprise first selecting circuitry 330, which may be configured (under suitable software instruction) to randomly select the first video game and/or one or more of the elements of the first video game. In embodiments of the present description, first selecting circuitry 330 may comprise one or more CPUs and/or GPUs in server 200 (such as CPUs 220 and/or GPUs 230, for example), and/or one or more CPUs and/or GPUs in client device 100 (such as CPUs 120 and/or GPUs 130, for example) connected (where necessary) via network 1 (through data ports 160 and 260, for example).

Using the above example of stored elements and metadata, first selecting circuitry 330 may be configured to select a video game title at random, and subsequently select, at random, N memory addresses having stored therein elements whose metadata matches that video game title.

Alternatively or in addition, embodiments of the present description may comprise second selecting circuitry 340, which may be configured (under suitable software instruction) to select the first video game and/or one or more of the elements of the first video game based on user preference data regarding one or more categories of entertainment media, the user preference data indicating one or more genres or types associated with each category of entertainment media. In embodiments of the present description, second selecting circuitry 340 may comprise one or more CPUs and/or GPUs in server 200 (such as CPUs 220 and/or GPUs 230, for example), and/or one or more CPUs and/or GPUs in client device 100 (such as CPUs 120 and/or GPUs 130, for example) connected (where necessary) via network 1 (through data ports 160 and 260, for example).

Using the above example of stored elements and metadata, the metadata of each element may also indicate the type/genre of the video game that is associated with that element.

In this case, second selecting circuitry 340 may be configured to determine a genre/type of video game that the user would likely be interested in based on their user preference data, that is, their preferred types/genres of different entertainment media categories (films, music, video games, and the like). Subsequently, second selecting circuitry 340 may be configured to select a first video game and/or one or more elements thereof whose metadata matches the determined genre/type of video game.

The user preference data may comprise one or more of: the user's gaming profile and the like (which may comprise data regarding the genres/types of video games the user currently/has previously played); the user's social media profile, such as their Facebook®, Instagram®, and/or Twitter® profiles, and the like (which may comprise data regarding the types of news/sports/culture/entertainment/hobbies the user currently is interested in); the user's video streaming profile, such as their Netflix® and/or YouTube® profiles, and the like (which may comprise data regarding the type of films/TV series/news/sports/culture/entertainment/hobbies the user is interested in); the user's music streaming profile, such as their Spotify® and/or YouTube® profiles, and the like (which may comprise data regarding the genres/types of music the user listens to); the user's response to a questionnaire or survey issued to the user during the current cloud gaming session prior to the streaming of the initial pieces of content, wherein generating circuitry 300 may be configured to issue the questionnaire or survey (the questionnaire/survey should elicit a response from the user that provides information regarding the categories of entertainment media and/or genres/types thereof that the user is interested in); and one or more video games determined by determining model 320 during one or more previous gaming sessions (that is, the video games that determining model 320 determined to be potentially interesting to the user during one or more previous gaming sessions with the gaming system described herein).

As will be appreciated by persons skilled in the art, such user preference data may be retrieved by second selecting circuitry 340 via a network such as the Internet.

In order for second selecting circuitry 340 to determine a genre/type of video game that the user would likely be interested in (and thereby select the first video game and/or elements thereof), selecting circuitry 340 may be comprise a trained selecting model, which may be any suitable machine learning model or neural network.

The selecting model may be trained prior to the current gaming session using labelled datasets, for example. Each dataset may comprise (notional) user preference data (horror films, heavy metal music, for example) and a label indicating a likely type/genre of video games that a user having this user preference data may be interested in (horror/survival games, for example).

Alternatively or in addition, the selecting model may be continuously trained to determine a genre/type of video game that a given user would likely be interested in based on the given user's user preference data and subsequent feedback from determining model 320 that the user did (not) find the first video game associated with the determined genre/type of video game interesting. For example, if the user enjoys listening to heavy metal and watching horror films, (an ill-trained) selecting model may determine sports games to be the genre that the user likes, and thus provides one or more initial pieces of content associated with sports games (football and basketball, for example). Determining model 320 may determine that the user is not interested in these initial pieces of content because the user skips them (that is, provides a skip signal) or provides a low rate of input signals during streaming of the initial pieces of content. Determining model 320 may provide this information to the selecting model, which is then trained to be less likely to determine sports games when a future (other) user with similar interests (heavy metal and horror films) initiates their own gaming session.

As a non-limiting example of a first (or given) portion of the virtual environment, generating circuitry 300 may be configured to select one or more elements of a given video game (an enemy boss character, a user-controlled character, a weapon, textures depicting brickwork, for example) and instantiate said elements into a room in a building (a first portion) of the virtual environment (by overlaying the walls of the room with the brickwork texture, placing the weapon on the floor, and placing the enemy boss and character in the room). This image and/or audio data of this populated room may subsequently be rendered (and optionally streamed to) client device 100 for display.

As will be appreciated by persons skilled in the art, the user may interact with the elements in the first portion in any way they desire.

Alternatively or in addition, an objective may be provided as part of the first portion (or indeed any given portion of the virtual environment). For example, a user interface (UI) element may be rendered as an overlay onto the image data of the first portion, the UI element comprising text which informs the user of an objective they may wish to complete. Turning back to the previous example, the overlaid objective maybe “pick up the weapon and kill the enemy boss”, for example. Alternatively or in addition, this objective may be provided in an audio format (such as a narrator reading out the objective to the user).

In order to determine a suitable objective for the user, generating circuitry 300 may take into account any metadata associated with the selected elements. For example, if metadata indicates that the element is an enemy NPC (such as the enemy boss), then generating circuitry 300 may determine an objective of killing/defeating said enemy NPC.

Hence more generally, generating circuitry 300 may be configured to generate, in dependence upon the elements comprised within the first portion (or a given portion), an objective associated with the first (or given) portion, and the objective may be rendered (as a UI element and/or narration) as part of the image data and/or audio data of the first (or given) portion.

In any case, once the elements of the first video game are instantiated within the first portion, the user may subsequently interact with the first portion (by controlling one of the elements, for example), and thereby determine whether or not they would enjoy playing the full release version of the first video game.

### Input Signals

In embodiments of the present description, it is desirable to ascertain the user's reactions to the first video game. This is so that portions populated later on in the current gaming session comprise parts of video games that the user is more likely to prefer/be interested in.

Accordingly, in embodiments of the present description, receiving circuitry 310 is configured to receive, from a user input device, input signals indicating a user's level of engagement during the user's interaction with the first portion. In embodiments of the present description, receiving circuitry 310 may comprise one or more data ports in server 200 (such as data port 260, USB ports, Ethernet® ports, Wi-Fi® ports, Bluetooth® ports, or the like), and/or one or more data ports in client device 100 (such as data port 260, USB ports, Ethernet® ports, Wi-Fi® ports, Bluetooth® ports, or the like) connected (where necessary) via network 1 (through data ports 160 and 260, for example).

The input signals may be received from one or more of: a user input device (game controller, motion controller, fitness tracker, smartphone touchscreen, mouse, keyboard, or the like); a camera (standalone or comprised within a computer, head mounted display, TV, user input device, or the like); and a microphone (standalone or comprised within a computer, head mounted display, TV, user input device, or the like).

It should be noted that the preceding examples are not exhaustive; persons skilled in the art will appreciate that types of devices operable to transmit input signals in response to user interactions therewith other than those mentioned previously are considered within the scope of the present description.

As will be appreciated by persons skilled in the art, the inputs signals received at receiving circuitry 310 may provide an indication of the user's reactions in response to the first portion (that is, the user's level of engagement).

As mentioned previously, these input signals may comprise control signals (from a games controller, mouse and keyboard, or the like) for controlling one of the first video game's elements (a character from the first video game, for example). For example, the rate at which input signals are received at receiving circuitry 310 during interaction with the first portion may provide an indication of the degree to which the user is engaging with the first portion, with higher rates indicating greater degrees of engagement.

Alternatively or in addition, the input signals may comprise control signals for controlling the current gaming session (pausing the gaming session, skipping portions of the virtual environment). For example, the time elapsed between the start of interaction with the first portion and the user providing a skip signal for skipping the first portion may provide an indication of the user's level of engagement, with a shorter times indicating lower levels of engagement in the first portion.

Alternatively or in addition, the input signals may comprise biometric data received at receiving circuitry 310 from the user's fitness tracker may indicate the user's emotional reaction to the content (fear, excitement, boredom, and the like). For example, increasingly higher heart rates may indicate increasing levels of engagement in the first portion. Alternatively or in addition, the input signals may comprise the results of a gaze tracking system may be received at receiving circuitry 310, these results indicating where the user was looking during streaming of the first portion, and thus what parts (elements) of the first portion the user found interesting (users typically look at objects they are interested in). Alternatively or in addition, the input signals may comprise signals from a microphone. For example, increasingly louder voices, screams and shouts may indicate increasing levels of interest in the first portion.

In any case, the input signals received may provide an indication as to the user's level of engagement in the first portion, and thus the first video game. Such input signals may therefore be used in order to determine other video games and/or elements thereof that the user may likely be interested in.

### Second Portion

In embodiments of the present description, determining circuitry 320 comprises a determining model that is trained to determine a second video game based on the first portion and the received input signals, and generating circuitry 300 is configured to instantiate a subset of a total number of elements of the second video game within a second portion of the virtual environment. In embodiments of the present description, determining model 320 may be comprised within software instructions which may be carried out by one or more CPUs and/or GPUs in server 200 (such as CPUs 220 and/or GPUs 230, for example), and/or one or more CPUs and/or GPUs in client device 100 (such as CPUs 120 and/or GPUs 130, for example) connected (where necessary) via network 1 (through data ports 160 and 260, for example). The determining model comprised within determining circuitry 320 may be any suitable machine learning model or neural network.

Optionally, where embodiments of the present description comprise rendering circuitry, then the rendering circuitry may be configured to render (and optionally stream), for display to the user, at least the second portion (once populated with elements, for example).

The determining model may be trained prior to the current gaming session using labelled datasets, for example.

For example, a given portion of the virtual environment populated with elements of a given video game may be generated by generating circuitry 300, and rendered for display for interaction by a plurality of test users, and the test users' input signals may be received at receiving circuitry 310. After interacting with the given portion, the test users may be issued a questionnaire or survey by generating circuitry 300. The questionnaire or survey may ask the users to rate their level of engagement/enjoyment/interest in the piece of content. The determining model may be provided with the given portion, the input signals and the responses to the questionnaire or survey (that is, labels), and learn how to correlate the input signals of a given test user with their level of engagement in the given portion.

Alternatively or in addition, the determining model may be provided with functions that represent general rules of thumb regarding input signals and user engagement. A given rule of thumb may outline a relationship between a factor associated with the received input signals and the user's engagement level. Example rules of thumb may relate increasing degrees/levels of user engagement to: increasing rates/amounts of received input signals; increasing rates/amounts of damage dealt/goals scored/XP earned (the input signals are such that control in-game characters in a goal-oriented manner); increasing rates/amounts of saccadic eye motions if gaze tracking is employed (the user's eyes are scanning the display screen on which the piece of content is displayed); increasing amounts of time spent gazing at a particular screen region (the user is focussed on a particular game element in the piece of content); increasing heart rates/breathing rates/galvanic skin response/body motion if using a fitness tracker; increasing speech volumes if using a microphone; and increasing periods of time between the start of a piece of content and the provision of a termination input signal (a skip signal).

As will be appreciated by persons skilled in the art, the above examples are non-limiting; there may be other ways to interpret/correlate inputs signals and user engagement level using rules of thumb. For example, while increasing speech volume may indicate increased user engagement (shouting, cheering, and the like), increasing periods of silence/low speech volume may also indicate increase user engagement (the user may be immersed in the content experienced/concentrating).

Optionally, the determining model may be continuously trained to determine a subsequent video game based on a current portion and the user's input signals. Turning back to the FPS game and RPG example, the determining model may have determined that the second portion should be populated with elements of the FPS game in response to the user providing input signals at rate considered to be low (when taking initial training of determining model 320 into account) and/or providing a skip signal during interaction with the first (RPG) portion. However, the user may have a similar reaction to the second (FPS) portion as they did with the RPG portion, and so the determining model may be further trained to determine future video games that are not FPS games or RPGs (a horror game, for example).

As will be appreciated by persons skilled in the art, this training may continue throughout the current gaming session in a cyclical manner, with the determining model continuously being trained to determine a third, fourth, fifth, N^{th} video game, based on the user's reactions to the first, second, third, fourth, and/or (N−1)^{th} portion(s).

Hence more generally, after the elements of the second video game are instantiated within the second portion by generating circuitry 300, operations of the gaming system are carried out in a cyclical manner until termination of the current gaming session, wherein each successive portion of the virtual environment has instantiated therein, by generating circuitry 300, a subset of a total number of elements of a respective video game that has been determined by determining model 320 based on one or more previous portions of the virtual environment and the input signals, received by receiving circuitry 310, indicating the user's level of engagement during the user's interaction with one or more previous portions. As will be appreciated by persons skilled in the art, the current gaming session may be terminated by the user turning off their client device 100, by providing an environment termination signal for generating circuitry 300 to cease generating the virtual environment, or the like.

Optionally, where embodiments of the present description comprise rendering circuitry, then the rendering circuitry may be configured to render (and optionally stream), for display, at least the most recently populated portion.

In any case, the video game determined by determining model 320 to likely be interesting to the user has its elements instantiated within a second (subsequent) portion of the virtual environment by generating circuitry 300. This second (subsequent) portion of the virtual environment may then be rendered (and optionally) streamed for display at client device 100 for interaction by the user.

Optionally, the determining model may be trained to determine one or more of the elements of the second video game. As will be appreciated by persons skilled in the art, the elements to be used in the second portion may be determined by determining model 320 using similar methods to those used to determine the second video game.

For example, the aforementioned initial training may include questionnaires or surveys that ask what particular elements did a test user find interesting during gameplay of a given portion of the virtual environment. Alternatively or in addition, the determining model may employ rules of thumb such as increasing lengths of time spent gazing at/interacting with a particular element indicating increasing levels of engagement in that element.

Alternatively or in addition, embodiments of the present description may comprise third selecting circuitry 350, which may be configured (under suitable software instruction) to randomly select one or more of the elements of the second video game. In embodiments of the present description, third selecting circuitry 350 may comprise one or more CPUs and/or GPUs in server 200 (such as CPUs 220 and/or GPUs 230, for example), and/or one or more CPUs and/or GPUs in client device 100 (such as CPUs 120 and/or GPUs 130, for example) connected (where necessary) via network 1 (through data ports 160 and 260, for example).

As will be appreciated by persons skilled in the art, the operation of third selecting circuitry 350 may be analogous to that of first selecting circuitry 330.

Alternatively or in addition, embodiments of the present description may comprise fourth selecting circuitry 360, one or more of the elements of the second video game based on user preference data regarding one or more categories of entertainment media, the user preference data indicating one or more genres or types associated with each category of entertainment media. In embodiments of the present description, fourth selecting circuitry 360 may comprise one or more CPUs and/or GPUs in server 200 (such as CPUs 220 and/or GPUs 230, for example), and/or one or more CPUs and/or GPUs in client device 100 (such as CPUs 120 and/or GPUs 130, for example) connected (where necessary) via network 1 (through data ports 160 and 260, for example).

As will be appreciated by persons skilled in the art, the operation of fourth selecting circuitry 360 may be analogous to that of second selecting circuitry 340.

In any case, generating circuitry 300 may be configured to terminate the user's interaction with the first portion when a time duration of the user's interaction with the first portion meets a threshold time duration. In this way, the user is able to get a quick “feel” for a given video game before being presented with another portion. Therefore, within a given gaming session, the user may be able to sample more portions of the virtual environment, and thus a greater amount of video games.

Alternatively or in addition, and as mentioned previously, generating circuitry 300 may be configured to terminate the user's interaction with the first portion in response to a termination input signal (a “skip signal”) being received at receiving circuitry 310 during the user's interaction with the first portion. The user may not wish to play a certain portion due to not liking the (type/genre of) video game associated therewith. For example, if the portion relates to a horror game, and the user does not like horror games, then the user may provide a skip signal to stop interacting with the portion, and begin interacting with the next portion. As mentioned previously, this skip signal may be used by the determining model to interpret the user's response to the piece of content, and thus determine (elements of) video games the user likes or does not like.

As mentioned previously, terminating the user's interaction with the first (or any given) portion may be carried out by disabling the user's control of a first (given) user-controllable element within the first (given) portion and enabling the user to control a second (subsequent) user-controllable element within the second (subsequent) portion, for example. Alternatively, terminating the user's interaction with the first (or any given) portion may be carried out by relocating a user-controllable element from the first (given) portion to the second (subsequent) portion.

In any case, embodiments of the present description seek to enable users to sample video games in a more environmentally friendly and less time consuming manner; embodiments of the present description contemplate a gaming system which removes the need for demo disks such as magazine bonus disks, and removes the need for downloading each video game's full virtual environments separately and in advance.

### Variant Embodiments

As mentioned previously, in embodiments of the present description, generating circuitry 300 may comprised within server 200. In such embodiments, server 200 may comprise rendering circuitry (one or more CPUs 220 and/or one or more GPUs 230, for example) configured to render image and/or audio data of at least a part of the virtual environment, and streaming circuitry (data port 260, and one or more CPUs 220 and/or one or more GPUs 230, for example) configured to stream (via network 1, for example) the rendered image and/or audio data to a client device (such as client device 100) for interaction by the user.

As will be appreciated by persons skilled in the art, the part of the virtual environment being rendered may comprise the portion of the virtual environment with which the user is interacting (via a user-controllable element, for example).

As will be appreciated by persons skilled in the art, by having this cloud gaming arrangement where server 200 generates the virtual environment, and renders and streams image and/or audio date of a part thereof, then the need for downloading each video game's virtual environment (or even smaller amount of game data pertaining to game elements) may be eliminated. Also, server 200 may have greater computational resources compared to that of client device 100, and so the virtual environment and instantiated elements may be rendered with greater fidelity/resolution and/or at a higher frame rate, leading to a more immersive gaming experience for users.

Alternatively, generating circuitry 300 may be comprised within client device 100. In such embodiments, client device 100 may comprise a memory (RAM 140 and/or SSD 150, for example) and retrieving circuitry (data port 160, and one or more CPUs 120 and/or one or more GPUs 130, for example) configured to download elements of video games over a network (such as network 1), and store the downloaded elements in the memory of the client device. Accordingly, generating circuitry 300 may be configured to retrieve, from the memory of client device 100, elements of a given video game that are to be instantiated within a given portion of the virtual environment.

As will be appreciated by persons skilled in the art, having this local virtual environment generation may result in a reduction in the amount of data to be downloaded onto client device(s) 100; rather than downloading virtual environments for each video game, certain parts thereof (such as characters, objects, in-game music, and the like), may instead be downloaded for use in the generated virtual environment, thereby reducing the bandwidth requirements and download times heretofore associated with playing demos of video games.

In either case, the need for demo disks such as magazine bonus disks may be eliminated.

Additionally in either case, by providing a single virtual environment and instantiating elements of video games within respective portions thereof reduces the amount of downtime or latency between completing/ending one video game experience and beginning another; rather than having to terminate execution of a given demo and begin execution of another, the user may simply move to a different portion of the virtual environment or be given control of a different element (character, for example) located in the different portion. This also offers an advantage in the efficiency of the operation of the system; rather than loading an entirely new virtual environment for each game experience, a number of elements or assets can be reused or maintained-thereby reducing the processing burden associated with each new experience.

Regardless of whether the device is comprised within client device 100 or server 200, the subset of elements of a given video game instantiated by generating circuitry 300 within a given portion may be made dependent upon a type of client device 100 via which the user interacts with the given portion. That is to say that the capabilities of the specific client device 100 used by the user may be taken into account when instantiating game elements into a given portion.

For example, a type and/or number of elements to be instantiated within a given portion may be determined based on the type and/or connectivity of client device 100 being used by the user for interaction.

For example, if a local arrangement is used and client device 100 is a previous generation (or other legacy) games console, then generating circuitry 300 may instantiate fewer elements and/or less geometrically-complex elements than if the client device 100 were a current generation games console because the previous generation/legacy console may have comparatively fewer/less complex computational resources for generating and rendering the given portion. In some cases, the elements may be generated specifically for legacy devices (or a specific legacy device) to ensure compatibility and suitability.

As another example, if a cloud gaming arrangement is used and client device 100 is one with a relatively poor network connection to server 200 compared with other client devices 100 connected thereto, then generating circuitry 300 may instantiate fewer elements in order to reduce bandwidth requirements associated with transmitting rendered image data of the given portion to the poorly connected client device 100.

### Gaming Method

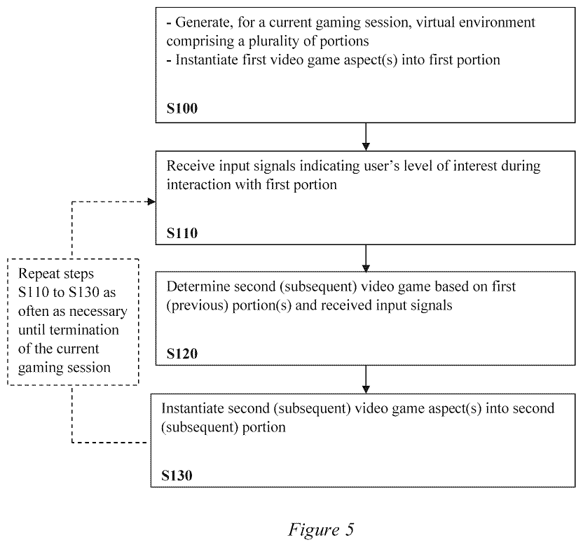

Turning now to FIG. 5, a gaming method comprises the following steps:

Step S100: generating, for a current gaming session, a virtual environment comprising a plurality of portions, wherein the generating step comprises instantiating a subset of a total number of elements of a first video game within a first portion of the virtual environment, as described elsewhere herein.

Step S110: receiving, from a user input device, input signals indicating a user's level of engagement during the user's interaction with the first portion, as described elsewhere herein.

Step S120: determining a subsequent video game, wherein the determining model is trained based on the initial pieces of content and the received input signals, as described elsewhere herein.

Step S130: instantiating a subset of a total number of elements of the second video game within a second portion of the virtual environment, as described elsewhere herein.

As will be appreciated by persons skilled in the art, steps S110-S130 may be performed in a cyclical manner, this cycle continuing for as long as necessary until termination of the current cloud gaming session in order provide the user with demos of video games in a successive manner, where each successive portion of the virtual environment has instantiated therein a subset of a total number of elements of a respective video game that has been determined by the determining model based on one or more previous portions of the virtual environment and the received input signals indicating the user's level of engagement during the user's interaction with one or more previous portions.

It will be apparent to a person skilled in the art that variations in the above method corresponding to operation of the various embodiments of the apparatus as described and claimed herein are considered within the scope of the present invention.

It will be appreciated that the above methods may be carried out on conventional hardware (such as entertainment device 100, 200) suitably adapted as applicable by software instruction or by the inclusion or substitution of dedicated hardware.

Thus the required adaptation to existing parts of a conventional equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

Embodiments of the present disclosure may be implemented in accordance with any one or more of the following numbered clauses:

1. A gaming system, comprising: generating circuitry configured to generate, for a current gaming session, a virtual environment comprising a plurality of portions, wherein the generating circuitry is configured to instantiate a subset of a total number of elements of a first video game within a first portion of the virtual environment; receiving circuitry configured to receive, from a user input device, input signals indicating a user's level of engagement during the user's interaction with the first portion; and determining circuitry comprising a determining model trained to determine a second video game based on the first portion and the received input signals; wherein the generating circuitry is configured to instantiate a subset of a total number of elements of the second video game within a second portion of the virtual environment.
2. A gaming system according to clause 1, wherein, after the elements of the second video game are instantiated within the second portion by the generating circuitry, operations of the gaming system are carried out in a cyclical manner until termination of the current gaming session, wherein each successive portion of the virtual environment has instantiated therein, by the generating circuitry, a subset of a total number of elements of a respective video game that has been determined by the determining model based on one or more previous portions of the virtual environment and the input signals, received by receiving circuitry, indicating the user's level of engagement during the user's interaction with one or more previous portions.
3. A gaming system according to clause 1 or clause 2, comprising first selecting circuitry configured to randomly select the first video game and/or one or more of the elements of the first video game.
4. A gaming system according to any preceding clause, comprising second selecting circuitry configured to select the first video game and/or one or more of the elements of the first video game based on user preference data regarding one or more categories of entertainment media, the user preference data indicating one or more genres or types associated with each category of entertainment media.
5. A gaming system according to clause 4, wherein the user preference data comprises one or more selected from the list consisting of: (i) the user's gaming profile; (ii) the user's social media profile; (iii) the user's video streaming profile; (iv) the user's music streaming profile; (v) the user's response to a questionnaire or survey issued to the user during the current gaming session prior to the streaming of the initial pieces of content, wherein the generating circuitry is configured to issue the questionnaire or survey; and (vi) one or more video games determined by the determining model during one or more previous gaming sessions.
6. A gaming system according to any preceding clause, wherein the determining model is trained to determine one or more of the elements of the second video game.
7. A gaming system according to any preceding clause, comprising third selecting circuitry configured to randomly select one or more of the elements of the second video game.
8. A gaming system according to any preceding clause, comprising fourth selecting circuitry configured to select one or more of the elements of the second video game based on user preference data regarding one or more categories of entertainment media, the user preference data indicating one or more genres or types associated with each category of entertainment media.
9. A gaming system according to any preceding clause, wherein the generating circuitry is configured to: terminate the user's interaction with the first portion when a time duration of the user's interaction with the first portion meets a threshold time duration; and/or terminate the user's interaction with the first portion in response to a termination input signal being received at the receiving circuitry during the user's interaction with the first portion.
10. A gaming system according to any preceding clause, wherein the generating circuitry is comprised within a server; and wherein the server comprises rendering circuitry configured to render image and/or audio data of at least a part of the virtual environment, and streaming circuitry configured to stream the rendered image and/or audio data to a client device for interaction by the user.
11. A gaming system according to any of clauses 1-9, wherein the generating circuitry is comprised within a client device; wherein the client device comprises a memory and retrieving circuitry configured to download elements of video games over a network, and store the downloaded elements in the memory of the client device; and wherein the generating circuitry is configured to retrieve, from the memory of the client device, elements of a given video game that are to be instantiated within a given portion of the virtual environment.
12. A gaming system according to any preceding clause, wherein the subset of elements of a given video game instantiated by the generating circuitry within a given portion is dependent upon a type of client device via which the user interacts with the given portion.
13. A gaming system according to any preceding clause, wherein an element of a given video game comprises one selected from the list consisting of: (i) a virtual character; (ii) a virtual object; (iii) image data of one or more virtual characters and/or one or more virtual objects; (iv) a texture; (v) a user interface, UI, element; (vi) an in-game sound effect; and (vii) at least a part of the given video game's soundtrack or musical score.
14. A gaming method, comprising: generating, for a current gaming session, a virtual environment comprising a plurality of portions, wherein the generating step comprises instantiating a subset of a total number of elements of a first video game within a first portion of the virtual environment; receiving, from a user input device, input signals indicating a user's level of engagement during the user's interaction with the first portion; determining, using a trained determining model, a second video game based on the first portion and the received input signals; and instantiating a subset of a total number of elements of the second video game within a second portion of the virtual environment.
15. A computer program comprising computer executable instructions adapted to cause a computer system to perform the method of clause 14.

1. A gaming system, comprising:
generating circuitry configured to generate, for a current gaming session, a virtual environment comprising a plurality of portions, wherein the generating circuitry is configured to instantiate a subset of a total number of elements of a first video game within a first portion of the virtual environment;
receiving circuitry configured to receive, from a user input device, input signals indicating a user's level of engagement during the user's interaction with the first portion; and
determining circuitry comprising a determining model trained to determine a second video game based on the first portion and the received input signals;
wherein the generating circuitry is configured to instantiate a subset of a total number of elements of the second video game within a second portion of the virtual environment.

2. The gaming system of claim 1, wherein, after the elements of the second video game are instantiated within the second portion by the generating circuitry, operations of the gaming system are carried out in a cyclical manner until termination of the current gaming session, wherein each successive portion of the virtual environment has instantiated therein, by the generating circuitry, a subset of a total number of elements of a respective video game that has been determined by the determining model based on one or more previous portions of the virtual environment and the input signals, received by receiving circuitry, indicating the user's level of engagement during the user's interaction with one or more previous portions.

3. The gaming system of claim 1, comprising first selecting circuitry configured to randomly select the first video game and/or one or more of the elements of the first video game.

4. The gaming system of claim 1, comprising second selecting circuitry configured to select the first video game and/or one or more of the elements of the first video game based on user preference data regarding one or more categories of entertainment media, the user preference data indicating one or more genres or types associated with each category of entertainment media.

5. The gaming system of claim 4, wherein the user preference data comprises one or more selected from the list consisting of:
i. the user's gaming profile;
ii. the user's social media profile;
iii. the user's video streaming profile;
iv. the user's music streaming profile;
V. the user's response to a questionnaire or survey issued to the user during the current gaming session prior to the streaming of the initial pieces of content, wherein the generating circuitry is configured to issue the questionnaire or survey; and
vi. one or more video games determined by the determining model during one or more previous gaming sessions.

6. The gaming system of claim 1, wherein the determining model is trained to determine one or more of the elements of the second video game.

7. The gaming system of claim 1, comprising third selecting circuitry configured to randomly select one or more of the elements of the second video game.

8. The gaming system of claim 1, comprising fourth selecting circuitry configured to select one or more of the elements of the second video game based on user preference data regarding one or more categories of entertainment media, the user preference data indicating one or more genres or types associated with each category of entertainment media.

9. The gaming system of claim 1, wherein the generating circuitry is configured to:
terminate the user's interaction with the first portion when a time duration of the user's interaction with the first portion meets a threshold time duration; and/or
terminate the user's interaction with the first portion in response to a termination input signal being received at the receiving circuitry during the user's interaction with the first portion.

10. The gaming system of claim 1, wherein the generating circuitry is comprised within a server; and
wherein the server comprises rendering circuitry configured to render image and/or audio data of at least a part of the virtual environment, and streaming circuitry configured to stream the rendered image and/or audio data to a client device for interaction by the user.

11. The gaming system of claim 1, wherein the generating circuitry is comprised within a client device;
wherein the client device comprises a memory and retrieving circuitry configured to download elements of video games over a network, and store the downloaded elements in the memory of the client device; and
wherein the generating circuitry is configured to retrieve, from the memory of the client device, elements of a given video game that are to be instantiated within a given portion of the virtual environment.

12. The gaming system of claim 1, wherein the subset of elements of a given video game instantiated by the generating circuitry within a given portion is dependent upon a type of client device via which the user interacts with the given portion.

13. The gaming system of claim 1, wherein an element of a given video game comprises one selected from the list consisting of:
i. a virtual character;
ii. a virtual object;
iii. image data of one or more virtual characters and/or one or more virtual objects;
iv. a texture;
V. a user interface, UI, element;
vi. an in-game sound effect; and
vii. at least a part of the given video game's soundtrack or musical score.

14. A gaming method, comprising:
generating, for a current gaming session, a virtual environment comprising a plurality of portions, wherein the generating step comprises instantiating a subset of a total number of elements of a first video game within a first portion of the virtual environment;
receiving, from a user input device, input signals indicating a user's level of engagement during the user's interaction with the first portion;
determining, using a trained determining model, a second video game based on the first portion and the received input signals; and
instantiating a subset of a total number of elements of the second video game within a second portion of the virtual environment.

15. A non-transitory machine-readable storage medium which stores computer software which, when executed by a computer, causes the computer to perform a gaming method, the method comprising:
generating, for a current gaming session, a virtual environment comprising a plurality of portions, wherein the generating step comprises instantiating a subset of a total number of elements of a first video game within a first portion of the virtual environment;
receiving, from a user input device, input signals indicating a user's level of engagement during the user's interaction with the first portion;
determining, using a trained determining model, a second video game based on the first portion and the received input signals; and
instantiating a subset of a total number of elements of the second video game within a second portion of the virtual environment.
